(19) United States
(12) Patent Application Publication
(10) Pub. No.: US 2014/0245716 A1
(43) Pub. Date: Sep. 4, 2014

(54) TWIN-DOOR THRUST REVERSER

(71) Applicant: AIRCELLE, Gonfreville L'Orcher (FR)

(72) Inventor: Patrick GONIDEC, Bretx (FR)

(73) Assignee: AIRCELLE, Gonfreville L'Orcher (FR)

(21) Appl. No.: 14/273,778

(22) Filed: May 9, 2014

Related U.S. Application Data
(63) Continuation of application No. PCT/FR2012/052409, filed on Oct. 22, 2012.

(30) Foreign Application Priority Data
Nov. 9, 2011 (FR) 11/03406

(51) Int. Cl. F02K 1/76

(52) U.S. Cl. CPC F02K 1/766; F02K 1/763
USPC 60/226.2

(57) ABSTRACT

A thrust reverser for a turbojet aircraft engine nacelle includes a pair of twin doors including an upstream door and a downstream door which is connected to the upstream door by a connecting rod. The thrust reverse also includes an actuating cylinder for operating the upstream door between a direct jet position in which the two doors are closed and a reversed jet position in which the two doors are open and deflects a portion of a cold air stream flowing inside the nacelle. A locking system of the thrust reverser locks the upstream and downstream doors relative to one another by the operation of the actuating cylinder alone.

### CROSS-REFERENCE TO RELATED APPLICATIONS

This application is a continuation of International Application No. PCT/FR2012/052409, filed on Oct. 22, 2012, which claims the benefit of FR 11/03406, filed on Nov. 9, 2011. The disclosures of the above applications are incorporated herein by reference.

### FIELD

The present disclosure relates to a twin-door thrust reverser.

### BACKGROUND

The statements in this section merely provide background information related to the present disclosure and may not constitute prior art.

It is known from the prior art, in particular French patent application FR2754565, a twin-door thrust reverser, each pair of twin doors comprising an upstream door and a downstream door.

Such a thrust reverser allows for a high rate of trailing of cold air flowing inside the nacelle, and hence more effective braking of the aircraft at landing.

In such a thrust reverser, a number of locks must be provided to provide redundancy in order to eliminate any risk of accidental opening of the doors.

Specifically, to meet the ruling safety standards, three independent locking systems must be provided for each upstream and downstream door of each pair of twin doors.

A first locking system comprises a lock integral with the front frame of the thrust reverser, and cooperating with the upstream door of the pair of twin doors.

The downstream door being connected by a pair of connecting rods to the upstream door, this first locking system also provides the locking of the downstream door.

A second locking system comprises a system for synchronizing the opening of adjacent doors, such as the one disclosed by French patent application FR2823259: such a system makes it possible to prevent the opening of the upstream door (and therefore its associated downstream door) unless an adjacent upstream door is itself open.

A third locking system cooperates directly with the actuating cylinder of the upstream door.

Hence, in such an arrangement, there are two locking systems controlled by pairs of twin doors: the first and third systems mentioned above, only the second locking system is passive and does not therefore require any control means.

Thus, for a twin-door thrust reverser typically comprising four pairs of twin doors, eight controlled locks must be provided, which is heavy, complex and costly both in terms of installation and maintenance.

### SUMMARY

The present disclosure provides a thrust reverser for an aircraft turbojet engine nacelle, comprising:

at least a pair of twin doors comprising an upstream door, a downstream door connected by at least one connecting rod to the upstream door, and

at least one actuating cylinder of the upstream door, between a “direct jet” position wherein both doors are locked, and a “reverse jet” position wherein both doors are open and adapted to deflect at least a portion of the cold air flowing inside the nacelle,

This thrust reverser being characterized in that it comprises means for locking/unlocking said downstream and upstream doors to/from one another under the sole action of said actuating cylinder.

The locking of the upstream and downstream doors to/from one another constitutes a locking system independent of the above-mentioned first and second locking systems which, as such, does not require any specific control means, as the movements of the actuating cylinder alone at the opening and locking of doors make it possible to lock/unlock said doors.

Three independent locking systems are thus obtained for a pair of twin doors, comprising only one controlled lock: that of the above-mentioned first locking system.

Thus, for a thrust reverser comprising four pairs of twin doors, only four controlled locks are needed, which contributes quite considerably to easing, simplifying and reducing costs.

According to other features of the thrust reverser according to the present disclosure:

said locking/unlocking means comprise:

a hook pivotably mounted on said upstream door, between a locking position of a pin integral with said downstream door, and an unlocking position of said pin,

elastic means for returning said hook to its locking position,

a latch pivotably mounted on said upstream door between a blocking position wherein it holds said hook in its locking position and a release position, wherein it allows said hook to switch from its locking position to its unlocking position,

elastic means for returning said latch to its blocking position,

said actuating cylinder and said latch being arranged relative to each other so that the extension of said actuating cylinder rotates said latch toward its release position;

said hook and said latch are mounted pivotably around axes substantially perpendicular to the axes of rotation of the upstream and downstream doors and to the axis of the nacelle;

said hook and said latch are mounted pivotably around axes substantially parallel to the axes of rotation of the upstream and downstream doors;

said hook is pivotably mounted around an axis substantially parallel to the axis of the nacelle, and said latch is pivotably mounted around an axis substantially perpendicular to the axes of rotation of the upstream and downstream doors and to the axis of the nacelle;

said locking/unlocking means comprise:

a bolt slidably mounted in said upstream door, between a locking position of a striker formed in said downstream door, and an unlocking position of said striker,

elastic means for returning said bolt to its locking position,

a latch pivotally mounted on said upstream door and cooperating with said bolt so that rotation of said latch acts to make said bolt slide,

said actuating cylinder and said latch being arranged relative to each other so that extension of said actuating cylinder rotates said striker in a direction causing said bolt to slide toward its unlocking position;

said locking/unlocking means further include a yoke pivotably mounted on said upstream door around an axis substantially parallel to the axes of rotation of said upstream and downstream doors, and elastic means for returning said yoke to a position wherein it maintains said bolt in its unlocking position;

said downstream door comprises a bearing member, adapted to rotate said yoke against said elastic means;

said locking/unlocking means comprise:

a hook pivotally mounted on said downstream door, between a locking position of a pin integral with the fixed structure of said reverser, and an unlocking position of the pin,

elastic means for returning said hook to its locking position,

a latch pivotally mounted on said downstream door between a blocking position wherein it holds said hook in its locking position, and a release position, wherein it allows said hook to switch from its locking position to its unlocking position,

elastic means for returning said latch to its blocking position,

a cable having one end slidably mounted on said upstream door, and another end connected to said latch, so that extension of said actuating cylinder causes said cable to slide relative to said upstream door, and, consequently, said latch to rotate towards its release position.

The present disclosure also relates to a nacelle fitted with a thrust reverser according to the foregoing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically shows a twin-door reverser in a “direct jet” configuration;

FIG. 2 shows this reverser in a “reverse jet” configuration;

FIG. 3 shows an overview of twin doors with a locking system according to a first form of the present disclosure;

FIGS. 4 to 10 show said locking system in its different operating positions;

FIG. 11 is a block diagram of the operating circuit of a four twin doors of a thrust reverser, a locking device according to the aforementioned being arranged between the doors of each pair of twin doors;

FIGS. 12 to 15 illustrate a second locking system according to the present disclosure in its different operating positions;

FIGS. 16a, 16b, 16c, 16d show a third form of the locking system according to the present disclosure shown from different perspectives;

FIGS. 17a to 17d, 18a to 18d, 19a to 19d, and 20a to 20c illustrate said locking system in its different operating positions;

FIGS. 21a, 21b, 21c show a fourth form of the locking system according to the present disclosure, shown in different perspectives;

FIGS. 22a, 22b, 22c; 23a, 23b, 23c; 24a, 24b, 24c and 25a, 25b, 25c illustrate this locking system in its different operating positions;

FIG. 26 is a view similar to FIG. 3, illustrating a fifth form of a locking system according to the present disclosure;

FIG. 27 shows the locking system in its portion located in the upstream door, and

FIGS. 28-33 show the locking system in the area located in the downstream portion, in different operating positions.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

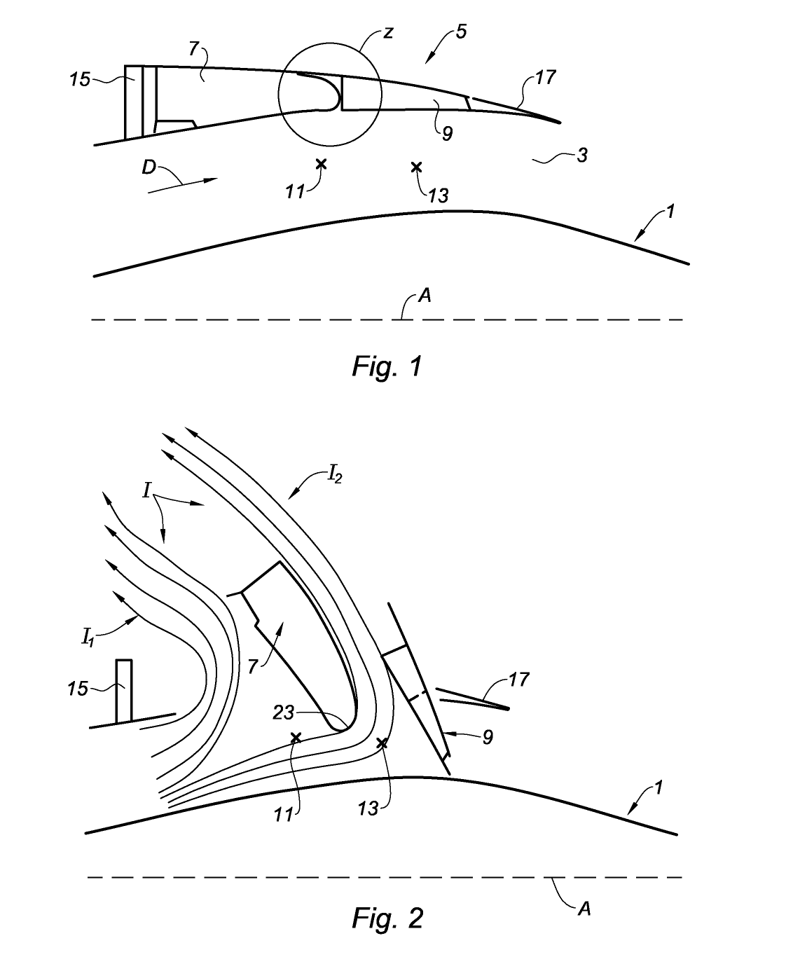

Referring to FIG. 1, wherein an inner fixed structure of a nacelle, designed for careening an aircraft turbojet engine (not shown) is shown.

Axis “A” of the turbojet engine is shown dotted in FIGS. 1 and 2, the upstream portion of said turbojet engine being located to the left of the figures, and the downstream portion to the right of said figures.

The inner fixed structure 1 can technically be made of composite material, and may have sound absorption characteristics so as to minimize the noise caused by circulation of cold air flow in the cold air vein 3.

This substantially annular cold air vein 3 is defined, on the one hand, by the inner fixed structure 1 and, on the other hand, by the peripheral portion of the nacelle, typically comprising a thrust reversal device 5.

Such thrust reversal device is movable between the configuration seen in FIG. 1, known as “direct jet” configuration, wherein cold airflow D flows inside the vein 3 from upstream to downstream of the nacelle, and the configuration seen in FIG. 2, known as “inverted jet” configuration wherein cold airflow “I” is rejected upstream of the nacelle, so as to exert a counterthrust force.

The “direct jet” configuration refers to aircraft takeoff and cruise flight situations, and the “reverse jet” configuration corresponds to an aircraft landing situation, wherein a minimized braking distance is sought.

More particularly, in the context of the present disclosure, the thrust reversal device 5 is a twin-door device.

This means that deflection of cold airflow upstream of the nacelle is obtained by means of two doors, respectively upstream door 7 and downstream door 9, hinged around axes of rotation 12 and 13, respectively.

It should of course be understood that several pairs of such twin doors can be provided at the periphery of the nacelle, only one such pair is however shown in the attached figures for the sake of simplification.

The upstream door 7 extends between the front frame 15, which constitutes a fixed portion of the nacelle, and the downstream door 9.

Said downstream door 9 extends between the upstream door 7 and the rear edge 17 of the nacelle.

In the configuration of FIG. 1, both doors 7 and 9 are closed, thus forcing cold airflow “D” driven by the turbojet engine fan (not shown) to flow inside the cold air vein 3, thereby providing necessary thrust to propel the aircraft (“direct jet” configuration).

It should be noted that the downstream door 9 has, on its outer upstream edge, a skin running to the outer downstream edge of the upstream door 7, providing the aerodynamic continuity of the outside part of the nacelle.

When it is desired to reverse the thrust of the nacelle, and thus switch to a “reverse jet” configuration, both doors 7 and 9 are opened by rotating them around the axes 11 and 13 respectively so as to bring them to their position shown in FIG. 2.

In this configuration, a portion “I1” of the cold airflow flowing inside the vein 3 is deflected upstream of the nacelle by the upstream door 7.

Another portion “I2” of the cold airflow passes between the downstream edge 23 of the upstream door 7 and the inner fixed structure 1 of nacelle 1, and is then deflected by the downstream door 9, which completely shuts-off the cold air vein 3.

In the following description, we will describe a system for locking the upstream 7 and downstream 9 doors, which is located in zone “Z” shown in FIG. 1.

To complete this description, we will use the directions in an XYZ coordinate system, wherein the X direction is substantially parallel to the axis “A” of the nacelle, Y is substantially parallel to the axes of articulation 11, 13 of the upstream 7 and downstream 9 doors, and Z is perpendicular to the X and Y directions.

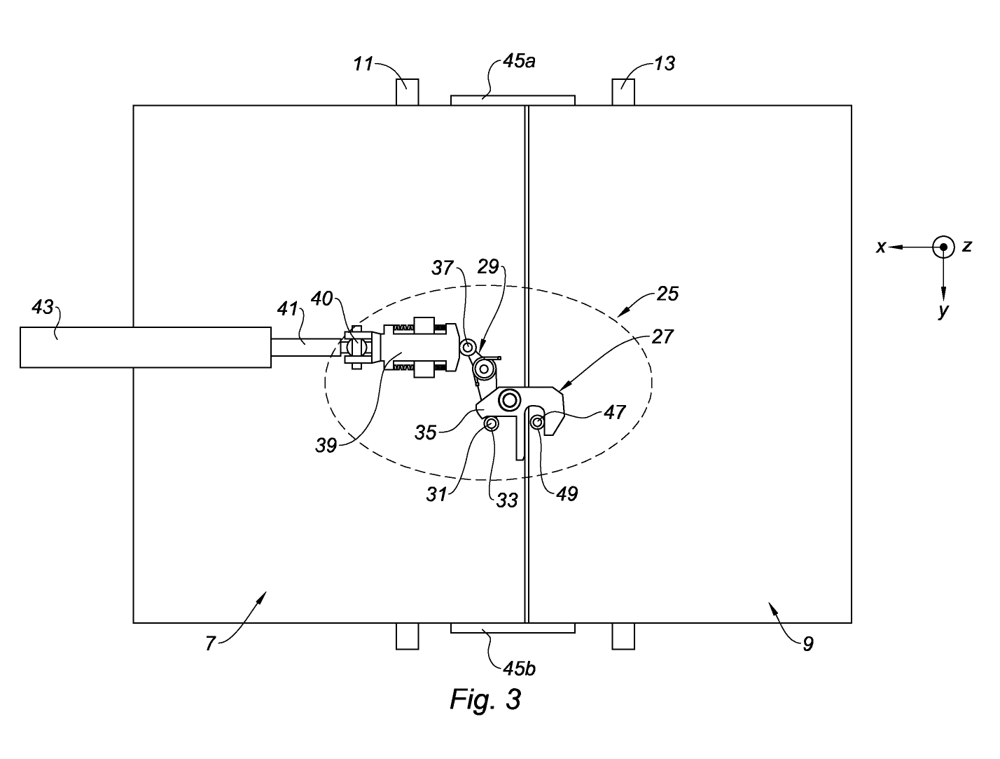

Referring to FIG. 3, it can be seen that locking system 25 according to the present disclosure is comprises a hook 27 pivotally mounted on the upstream door 7 around an axis of direction Z.

A blocking latch 29 is itself pivotally mounted on the upstream door 7 around another axis of direction Z.

Said blocking latch 29 comprises a tail 31 terminating in a roller 33, the tail being itself capable of cooperating with a tail 35 of the hook 27, so as to prevent the latter from rotating.

The latch 29 further comprises a head 37 capable of being pushed by a slider 39 slidably mounted on the underside of the upstream door 7, and connected by a hinge 40 to the end of the rod 41 of a hydraulic or electric actuating cylinder 43, said actuating cylinder allows the upstream door 7 to switch from its closed position (“direct jet”—FIG. 1) to its open position (“reverse jet”—FIG. 2).

It should be noted that the downstream door 9 is connected to the upstream door 7 by a pair of connecting rods 45a, 45b, arranged so that the opening/closing of the upstream door causes the opening/closing of the downstream door 9.

Hook 27 cooperates with a pin 47 extending substantially in direction Z, integral with the sliding hood, preferably surrounded by a roller 49.

Spiral springs 51, 53, respectively centered on the axes of rotation of the hook 27 and the latch 29, tend to respectively rotate these two bodies clockwise and anti-clockwise.

Belleville washers 54a, 54b provide elasticity and damping to the movements of the slider 39 relative to the upstream door 7. Without any action of the actuating cylinder 41 on the slider 39, the springs 54a and 54b are preferably adjusted so that the spring 54b keeps the slider 39 away from roller 37 to maintain the locking in case of a burst of actuating cylinder 41.

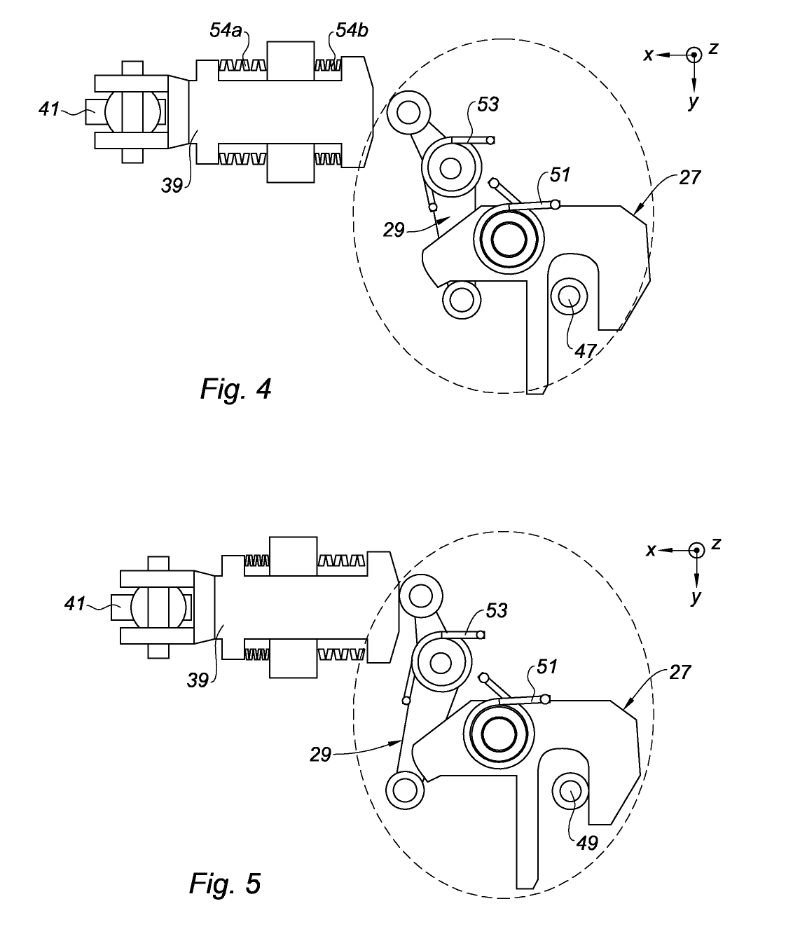

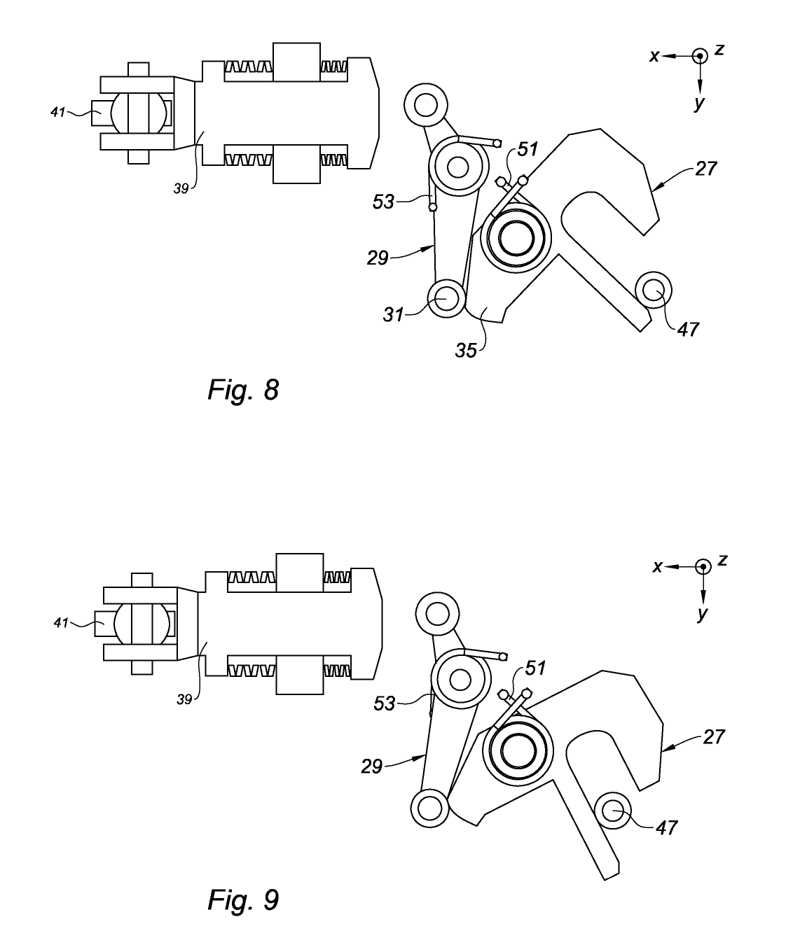

The locking system operation mode described above will now be explained in light of FIGS. 4 to 10.

In a “direct jet” configuration, the hook 27 is closed on the pin 47, as seen in FIG. 4, the tail 31 of latch 29 prevents rotation of said hook 27, and therefore any accidental opening of the upstream 7 and downstream 9 doors. It should be noted that there is no contact between the slider 39 and the roller 37 of the latch 29.

When it is desired to switch to a “reverse jet” configuration (FIG. 2), the actuating cylinder 43 is acted upon so that its rod 41 is extended, and thus causes the slider 39 to slide relative to upstream door 7 against the elasticity of Belleville washers 54a.

In so doing, as seen in FIG. 5, the end of the slider 39 acts on the head 37 of the latch 29, against the spiral spring 53 so that the tail 31 of the latch 29 releases the tail 35 of the hook 27.

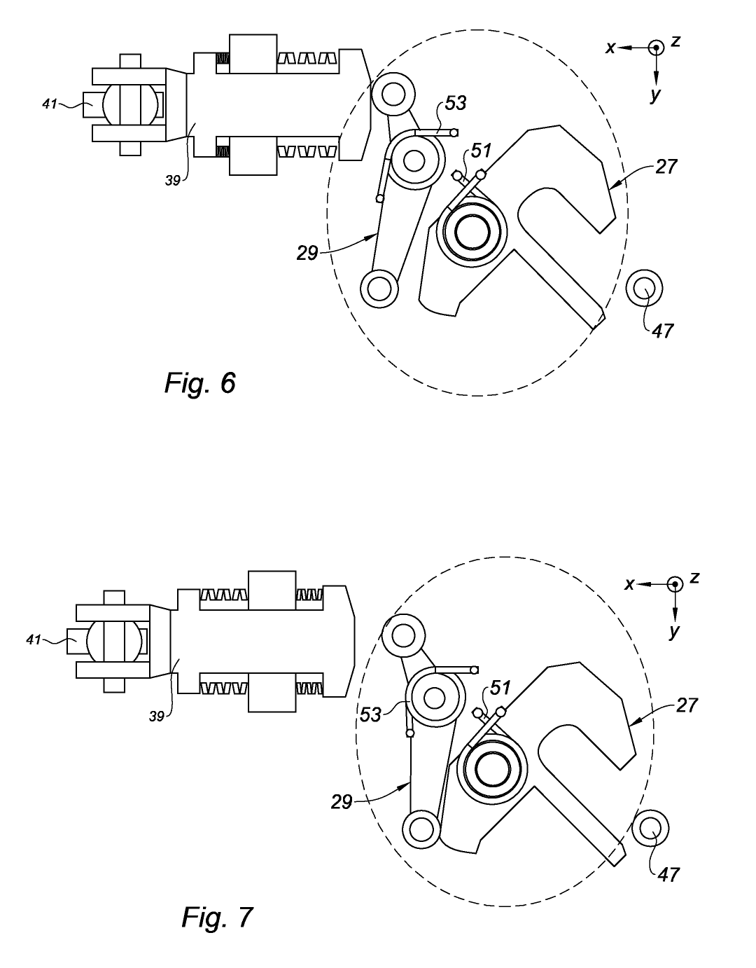

Thus, as seen in FIG. 6, under the effect of the spiral spring 51, the hook 27 rotates counterclockwise, thereby releasing the pin 47 of the downstream door 9.

Thus, under the effect of the extension of the rod 41 of the actuating cylinder 43, both upstream 7 and downstream doors 9 connected by the connecting rods 45a and 45b can rotate to their open position shown in FIG. 2, making it possible to send cold airflow to the front of the nacelle, and thus achieve the thrust reversal function.

When it is desired to return to a “direct jet” position (FIG. 1), the rod 41 of the actuating cylinder 43 is retracted, which in particular has the effect of pulling the pin 47 of the downstream door 9 within the hook 27 (see FIG. 7).

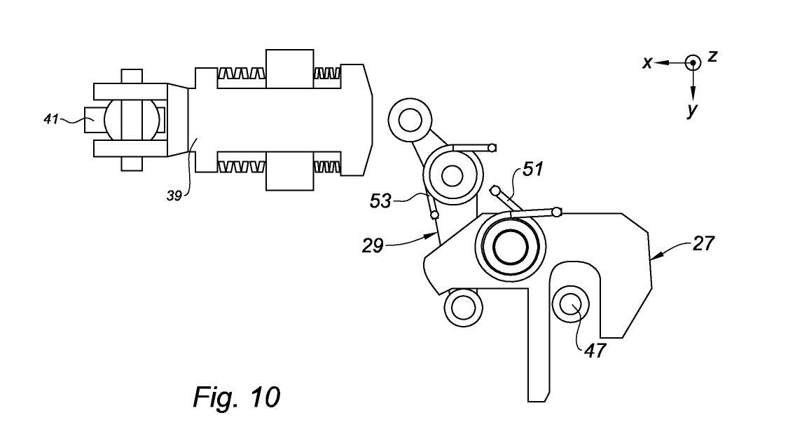

In so doing, the pin 47 eventually abuts against the hook 27 and rotates it clockwise, against the spiral spring (8 and 9), until the tail 35 of the hook 27 crosses the tail 31 of the latch 29, allowing the latter to return to its original position (FIG. 10): this is a configuration where the hook 27 blocks any relative movement between the upstream 7 and downstream 9 doors, thus achieving safe locking totally independent of the other locking systems.

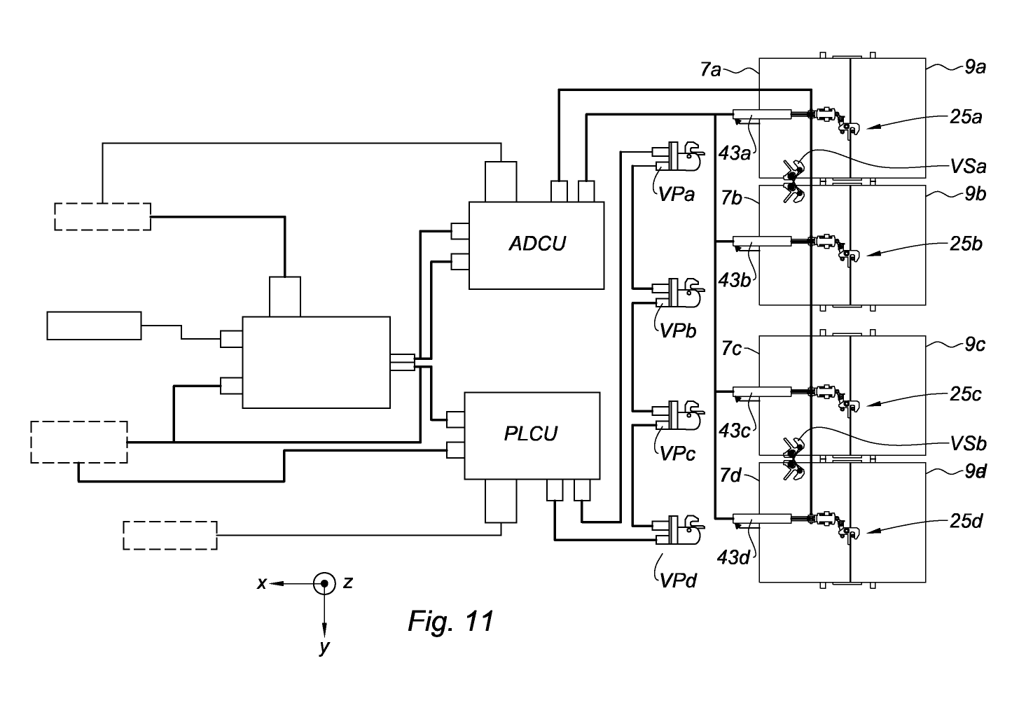

Referring to FIG. 11, the circuits for actuating and locking the four twin doors of the same thrust reverser can be seen synthetically, especially equipped with a locking system such as the one described above.

As seen in this FIG. 11, each upstream door 7a, 7b, 7c, 7d is actuated by a respective actuating cylinder 43a, 43b, 43c, 43d, which is capable of acting on a respective locking system 25a, 25b, 25c, 25d, disposed between the upstream 7a, 7b, 7c, 7d and the downstream doors 9a, 9b, 9c, 9d, in accordance with the above explanation.

As mentioned above, said locking systems 25a, 25b, 25c, 25d are independent of the two other locking systems, making it possible to prevent any accidental opening of the twin doors.

For each pair of twin doors, there is indeed a so-called “primary” locking system VPa, VPb, VPc VPd, acting directly on the upstream doors 7a, 7b, 7c, 7d, controlled by a specific control unit known as the primary lock control unit (PLCU).

Furthermore, synchronization locks VSa and VSb are disposed between two adjacent upstream doors, on the one hand, 7a, 7b and, on the other hand, 7c 7d, preventing an upstream door from opening unless its adjacent upstream door is itself open: such a system is known in the art including French Application FR 2,823,259, and therefore, will not be described in more detail here.

As can be seen in FIG. 11, the actuator directional control unit (ADCU) of the actuating cylinders 43a, 43b, 43c, 43d, is completely independent of the PLCU, so that the three locking systems described above (25, VP, VS) are completely independent of each other, thus providing perfectly safe locking of the doors of the thrust reverser in a “direct jet” position.

It should further be noted that the different axial positions of said three locking systems offer maximum prevention against accidents occurring inside the nacelle, such as rotor burst.

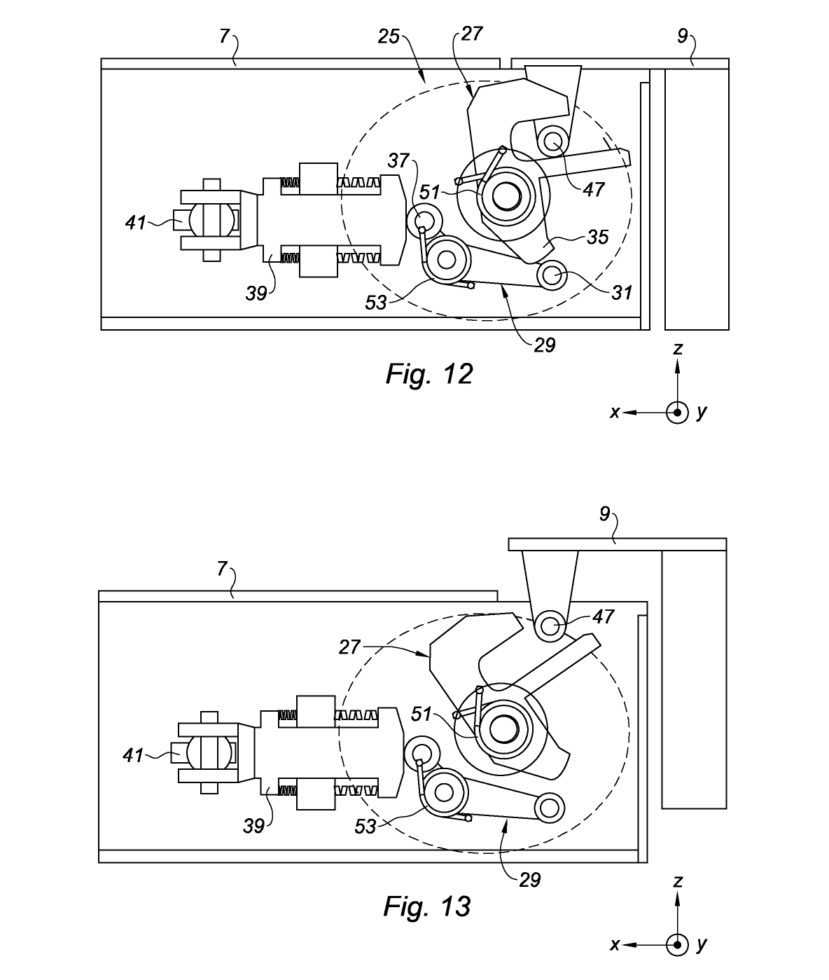

Referring now to FIGS. 12 to 15, wherein is shown another form of the locking system according to the present disclosure.

As will be understood from the XYZ axis system shown in these figures, the pivoting of the hook 27 and the latch 29 now occurs around axes parallel to direction Y.

In other words, in the present form, the rotation of the hook 27 and the latch 29 occurs around axes substantially parallel to the axes of rotation 11 and 13 of upstream 7 and downstream 9 doors, whereas in the previous form the axes of rotation of the hook 27 and the latch 29 were substantially perpendicular to the axes of rotation 11 and 13 of the doors 7 and 9, and to the axis “A” of the nacelle.

As in the previous form, an extension 41 of the rod of the actuating cylinder 43 acts to push the head 37 of the latch 29 against the spiral spring 53, thereby causing the latch to rotate clockwise and at the same time releasing the tail 35 of the hook 27, which can then rotate under the action of the spiral spring 51 counterclockwise, thereby releasing the pin 47 integral with the downstream door 9 (see FIGS. 12 and 13).

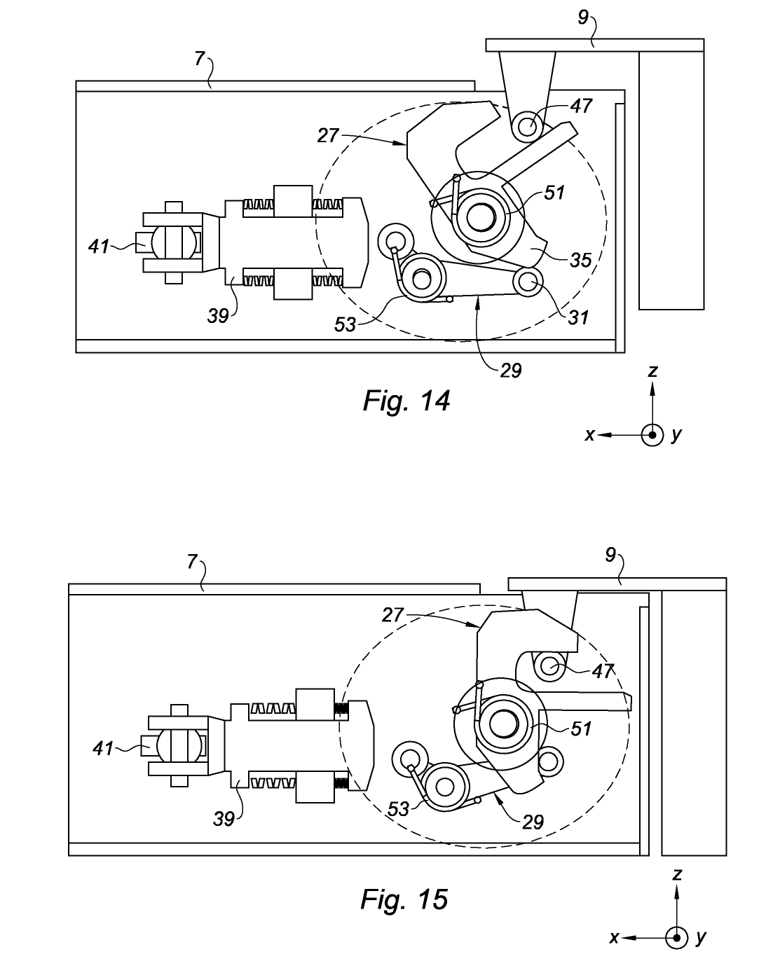

When the rod 41 of the actuating cylinder 43 retracts, it causes the reclosing of the downstream door 9 on the upstream door 7 by means of the connecting rods 45a and 45b, and the pin 47 is relocated within the hook 27, thereby causing it to rotate clockwise against the spiral spring 51 until the tail 35 of said hook bypasses the tail 31 of said latch 29 (see FIGS. 14 and 15), making it possible to block again the pin 47 in a position corresponding to the “direct jet” configuration of the nacelle.

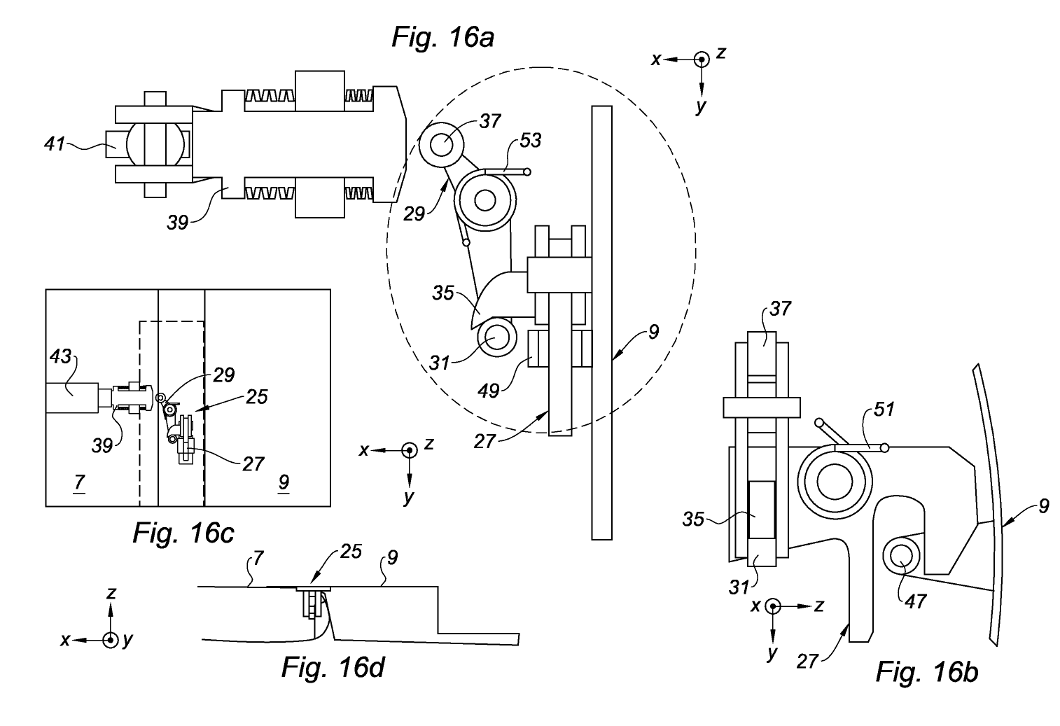

The form of FIGS. 16-20 differs from the two previous ones, in that the hook 27 is now pivotally mounted on the upstream door 7 around an axis substantially parallel to the axis “A” of the nacelle, the latch 29 being disposed substantially as in the first form described above.

As part of this particular arrangement, the tail 35 of hook 27 extends in a direction substantially parallel to the median plane of said hook, that is to say, in a direction substantially parallel to the axis “A” of the platform (direction X).

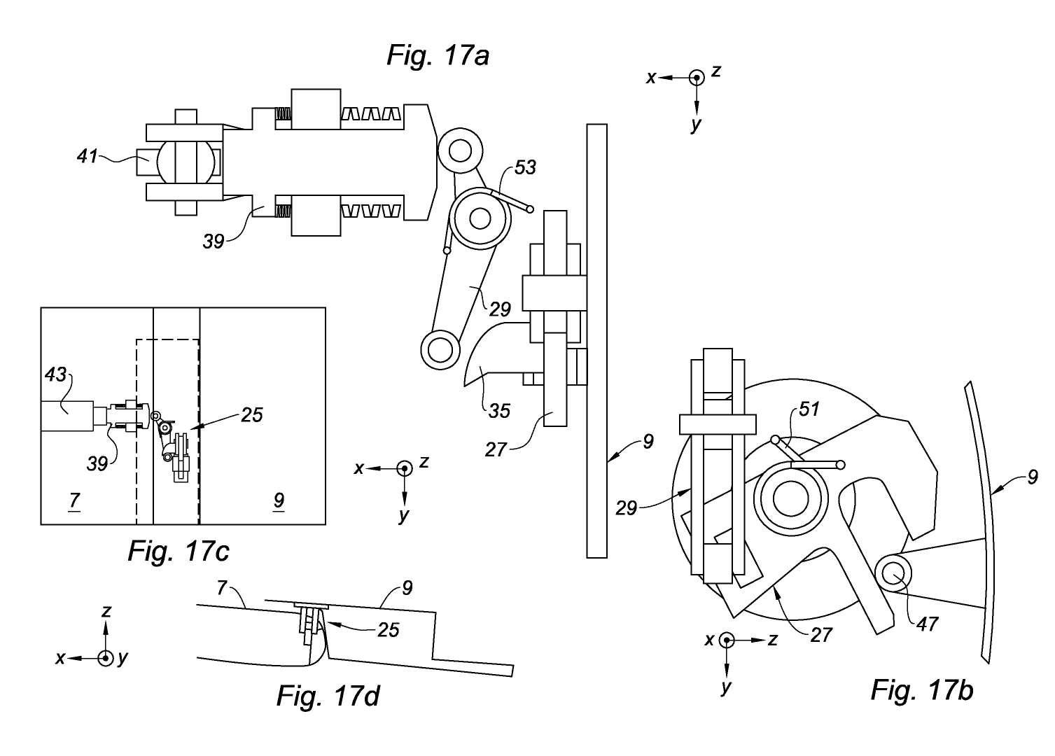

As in the two previous forms, the thrust exerted by the slider 39 on the head 37 of the latch 29, during the extension of the rod 41 of the actuating cylinder 43, acts to disengage the tail 31 of the latch 29 from that 35 of the hook 47 (see FIGS. 16 and 17), thereby releasing the pin 47, and at the same time making it possible to open the twin doors 7 and 9.

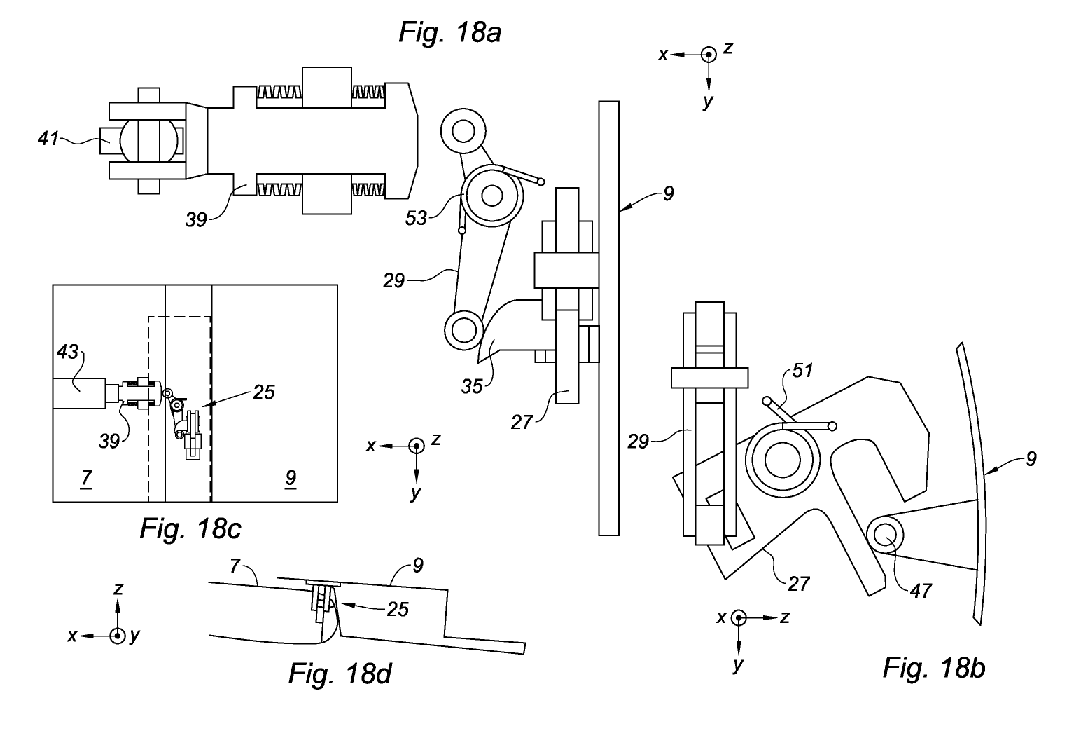

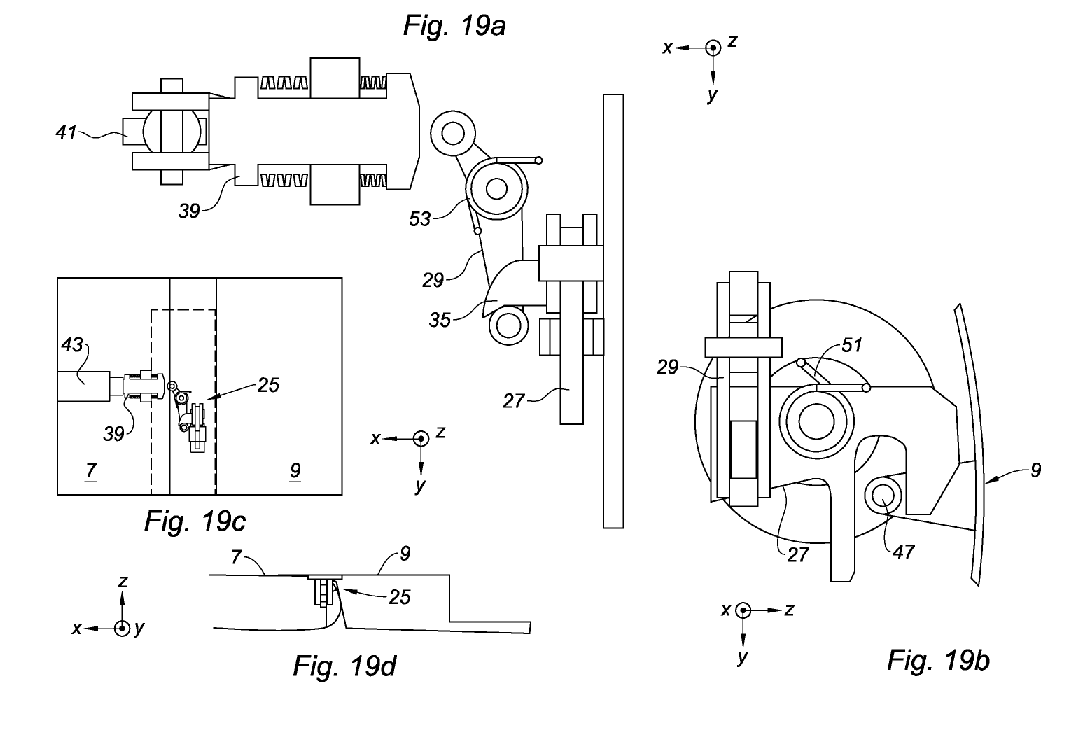

When the rod 41 of the actuating cylinder 43 is retracted (see FIG. 18), the twin doors 7 and 9 are closed, thereby bringing the pin 47 back into contact with the hook 27 which it rotates clockwise against the force exerted by the spiral spring 51, until the tail 35 of the hook 27 crosses the tail 31 of the latch 29 (see FIG. 19), thus providing the locking of both upstream 7 and downstream 9 doors relative to each other.

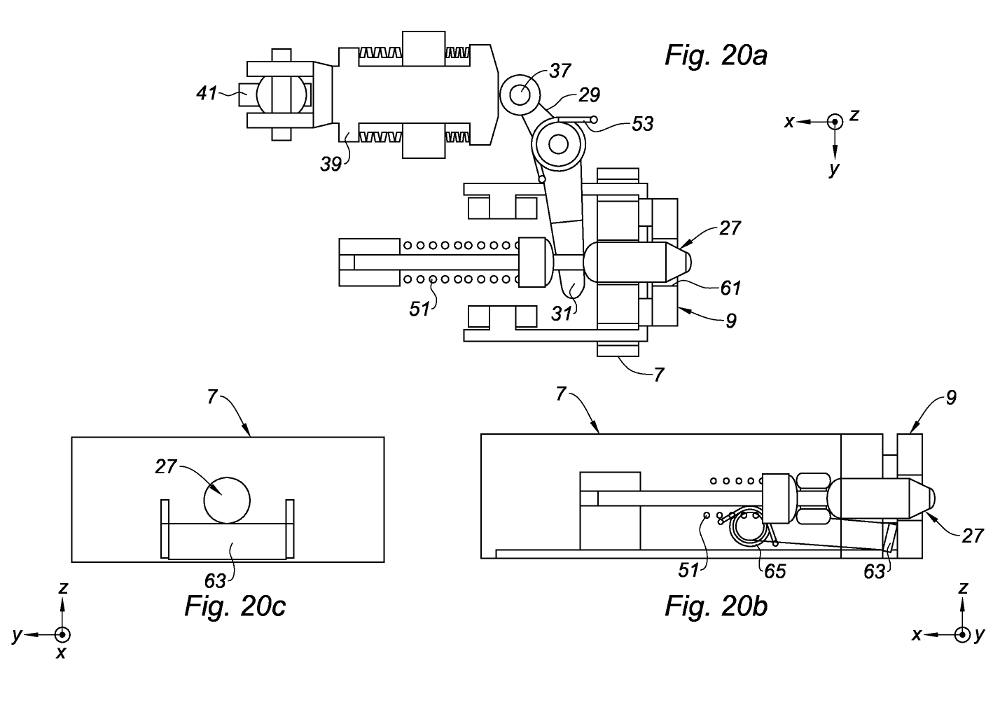

We now refer to FIGS. 20 to 26, wherein yet another form of the locking system according to the present disclosure is shown.

As seen in this form, there is a bolt 27 slidingly mounted within the upstream door 7, against a helical spring 51.

The movements of the bolt 27 are performed substantially in the X direction, that is to say, parallel to the axis “A” of the nacelle.

This bolt 27 is capable of moving against the helical spring 51 under the action of the tail 31 of the latch 29, when the latter is operated clockwise by the slider 39 mounted at the end of the rod 41 of the actuating cylinder 43. Said tail 31 may advantageously be yoke-shaped to surround the bolt 27.

The configuration of FIGS. 20a, 20b, 20c corresponds to the “direct jet” configuration wherein it is desired that the upstream 7 and downstream 9 doors be locked relative to each other.

In this configuration, the spring 51 is fully extended, so that the downstream end of the bolt 27 protrudes from the downstream edge of the door 7, and enters into a striker 61 (that is to say, in a corresponding orifice) formed on the upstream edge of the door 9.

Thus, the bolt 27, which is a shear bolt, prevents any relative movement of the upstream edge of the downstream door 9 relative to the downstream edge of the upstream door 7.

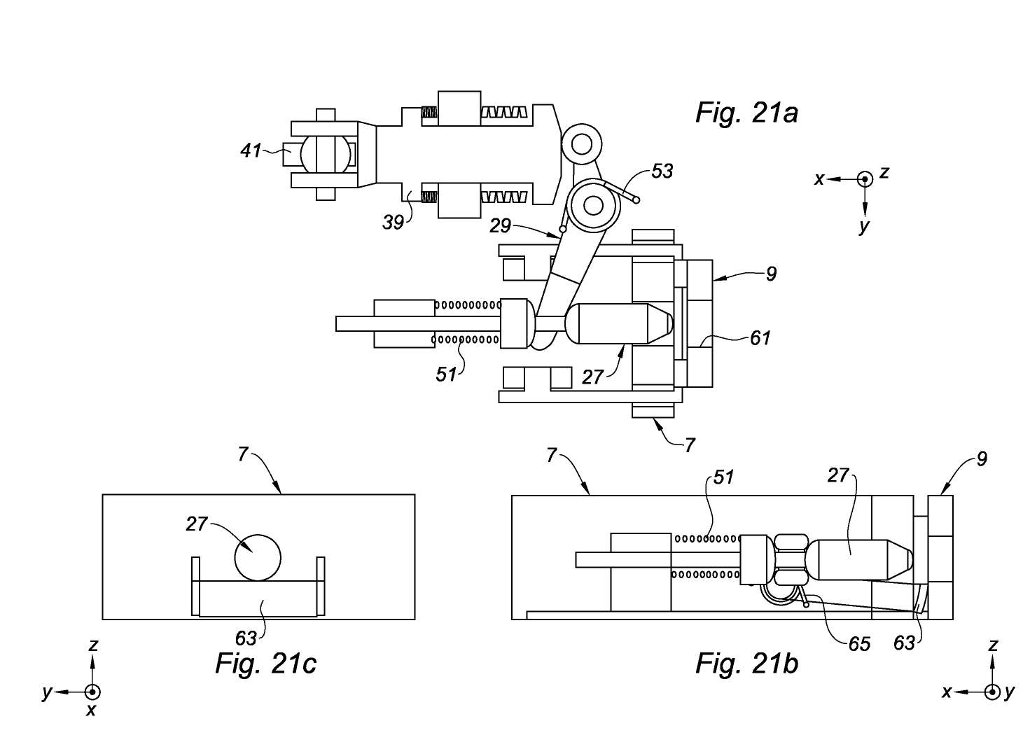

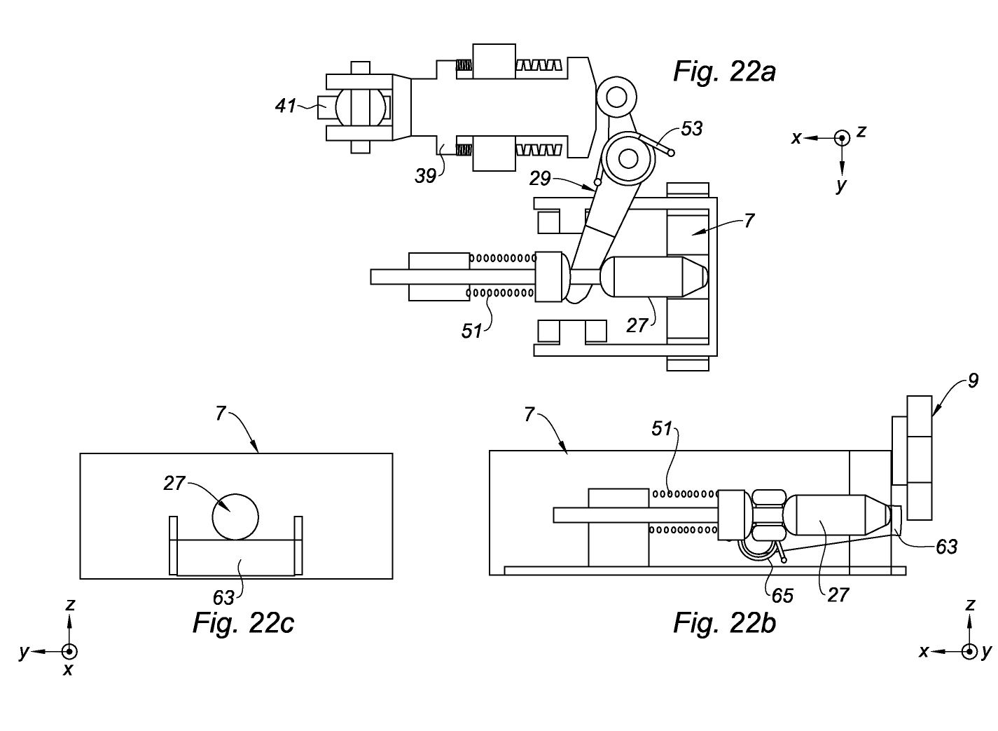

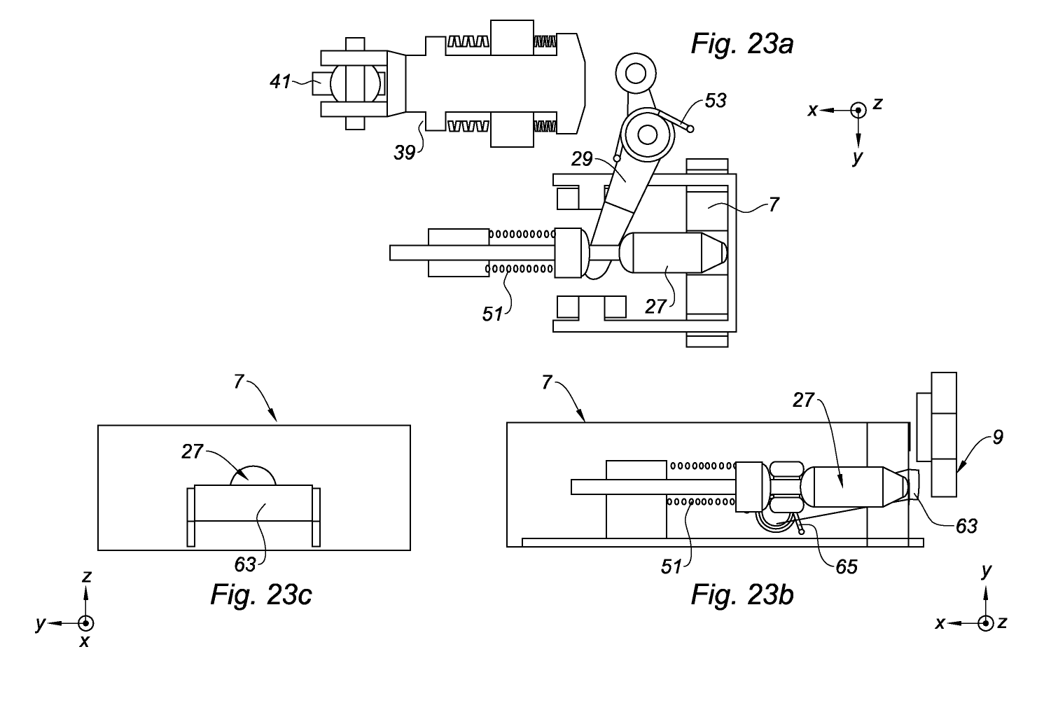

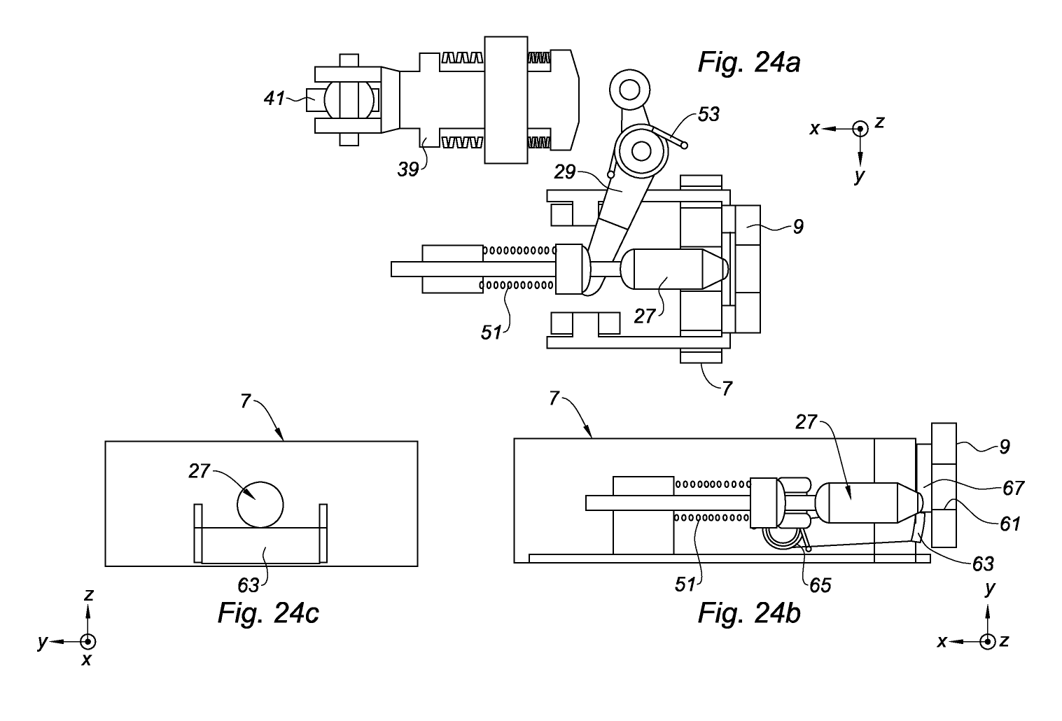

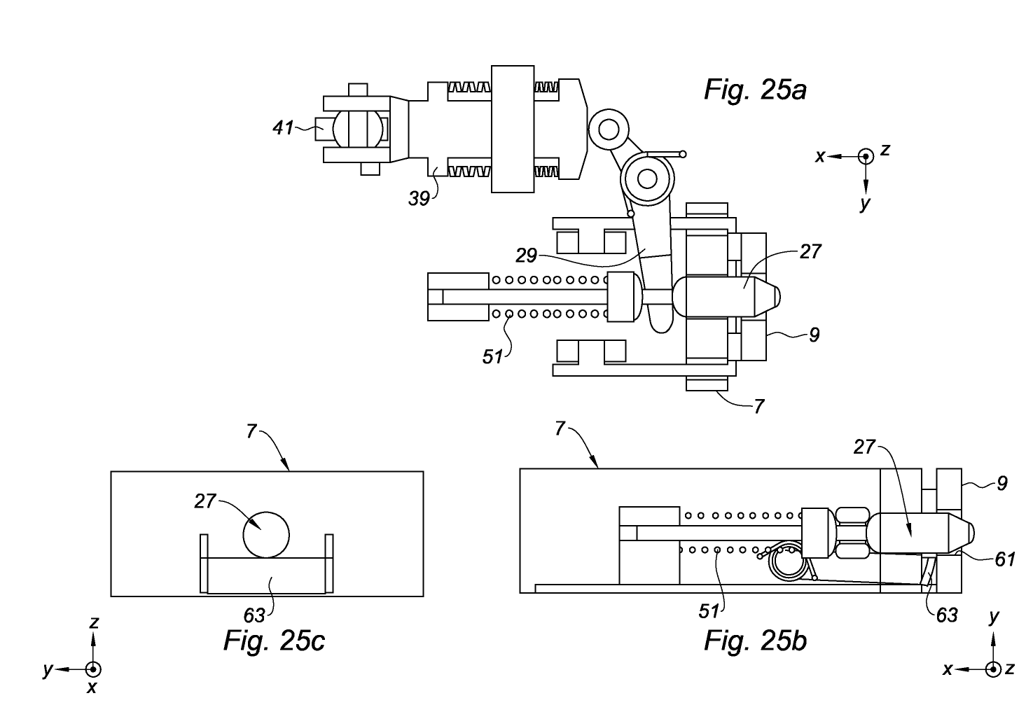

When it is desired to open on twin doors, the actuating cylinder 43 is acted upon in order to extend its rod 41, which has the effect of rotating the latch 29 clockwise, and thus translating the bolt 27, so that it compresses the helical spring 51, and therefore no longer protrudes from the downstream edge of the upstream door 7: the striker 61 is thus released so that the upstream edge of the downstream door 9 is no longer locked relative to the downstream edge of the upstream door 7 (see FIGS. 21a, 21b, 21c) and both doors may thus be opened (see FIGS. 22a, 22b, 22c).

During this opening, a yoke 63 pivotably mounted around an axis substantially parallel to the axes of rotation 11 and 13 of the upstream 7 and the downstream 9 doors, swivels around its axis under the action of a spiral spring 65 until it prevents the bolt 27 from protruding from the downstream edge of the upstream door 7.

When it is desired to reclose both doors 7 and 9 of the thrust reverser, the rod 41 of the actuating cylinder 43 is retracted, as seen in FIG. 23, which has the effect of bringing the downstream door 9 back to a position where it presses, by means of a bearing member 67, on the yoke 63 (see in particular FIGS. 24b and 24c), thereby causing said yoke 63 to rotate against the spiral spring 55 until the bolt 27 is released and is again relocated within the striker 61, under the action of its helical spring 51, as can be seen in particular in FIGS. 25a, 25b and 25c.

When the bolt 27 returns to said position, it provides again the relative blocking of the upstream 7 and downstream 9 doors, and thus perfectly holds the thrust reverser in its “direct jet” configuration (see FIG. 1).

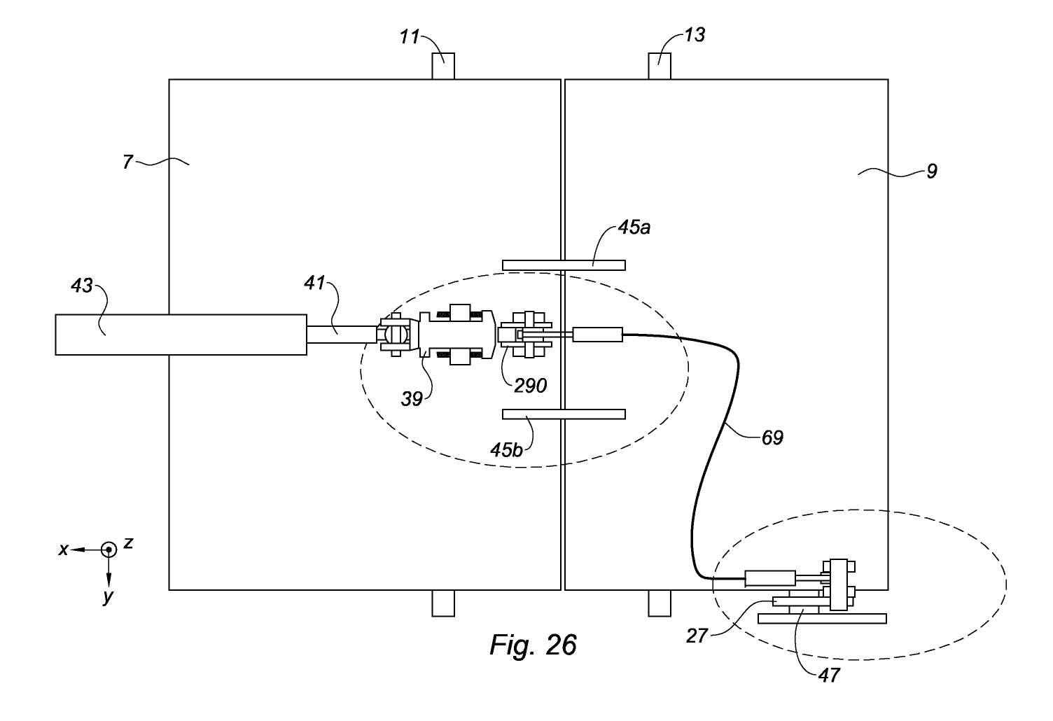

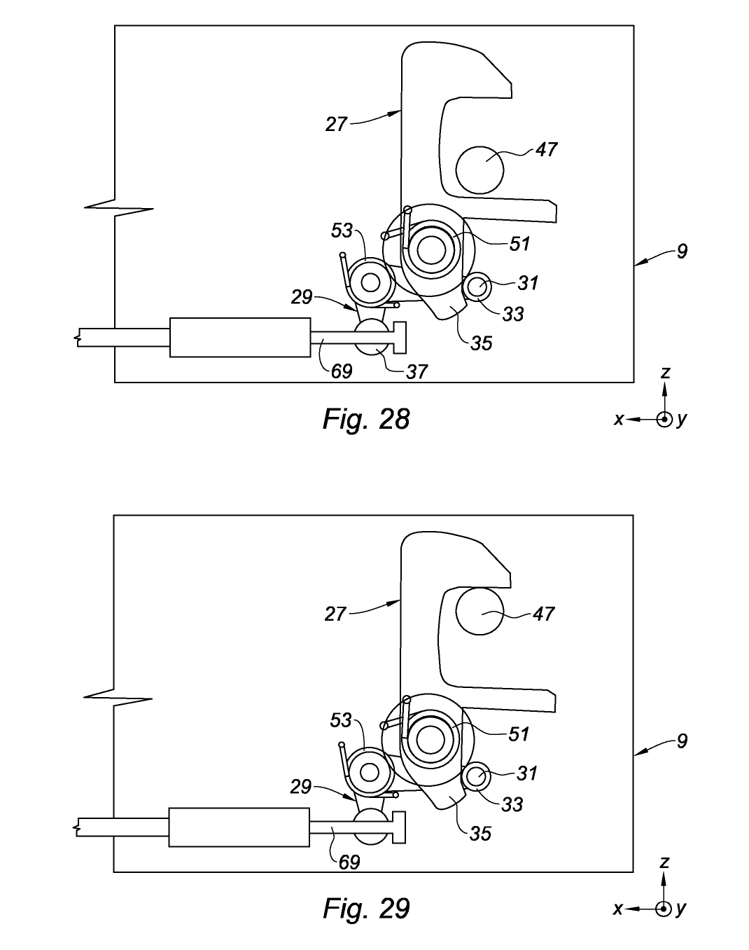

We now refer to FIGS. 26 to 34, wherein yet another form of the locking system according to the present disclosure is shown.

This form differs from the first three forms described above in that the pin 47 is now mounted on the fixed structure of the thrust reverser, in the vicinity of the downstream edge of the downstream door 9.

The hook 27 is itself mounted on the downstream door 9, to the right of the pin 47, rotating on an axis substantially parallel to the axes 11 and 13 of the two doors.

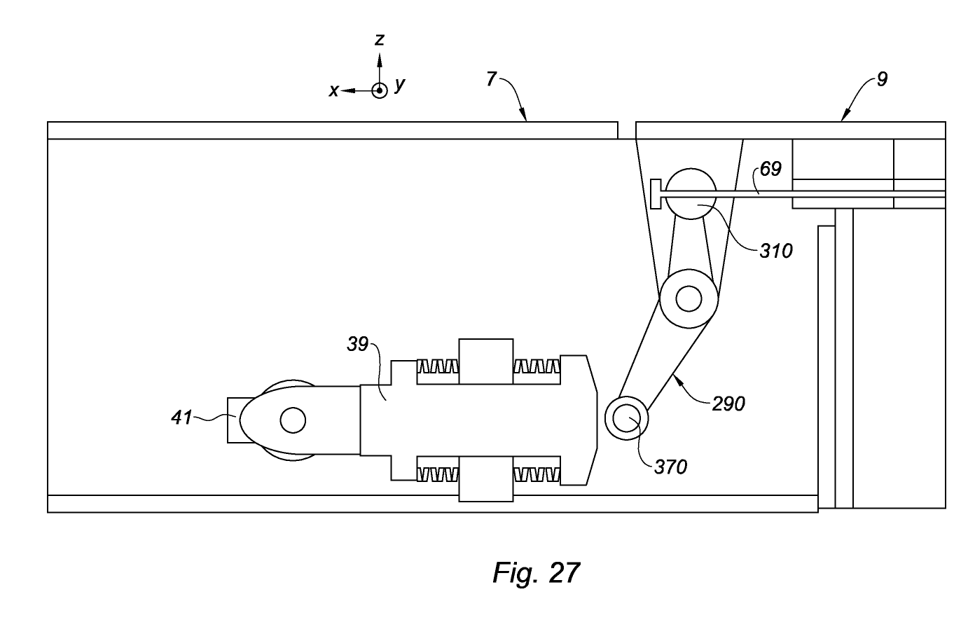

As can be seen in FIG. 27, a first latch 290 is pivotably mounted on the downstream hood 9, around an axis substantially parallel to the axes of rotation of the two upstream 7 and downstream 9 doors.

The head 370 of the first latch 290 is operable by the slider 39 mounted at the end of the rod 41 of the actuating cylinder 43.

The tail 310 of the first latch 290 cooperates with a cable 69 slidably mounted relative to the downstream door 9, and extending to a second latch 29, pivotably mounted around an axis substantially parallel to the axes 11 and 13 of downstream door 9, against a spiral spring 53.

The head 37 of the latch 29 cooperates with the cable 69 and the tail 31 of said latch 29 cooperates with a tail 35 of the hook 27, analogously to what has been stated for the previous forms.

More specifically, in a locking position of both doors 7 and 9, the slider 39 does not exert any force on the head 370 of the first latch 290, so that the second tail 31 of latch 29 blocks the tail 35 of hook 27, preventing the latter from rotating, and thus disengaging from the pin 47 integral with the fixed structure of the nacelle: the downstream door 9, and thereby the upstream door 7 (by means of connecting rods 45a and 45b) cannot therefore be opened.

FIG. 29 show the hook 27 abutting against the pin 47, in an attempted accidental opening.

When it is desired to open the upstream 7 and downstream 9 doors, the rod 41 of the actuating cylinder 43 is extended, which has the effect of moving the slider 39 which now rotates the first latch 290 counterclockwise.

In doing so, a tensile force is exerted on the cable 69 by the tail 310 of the latch 290.

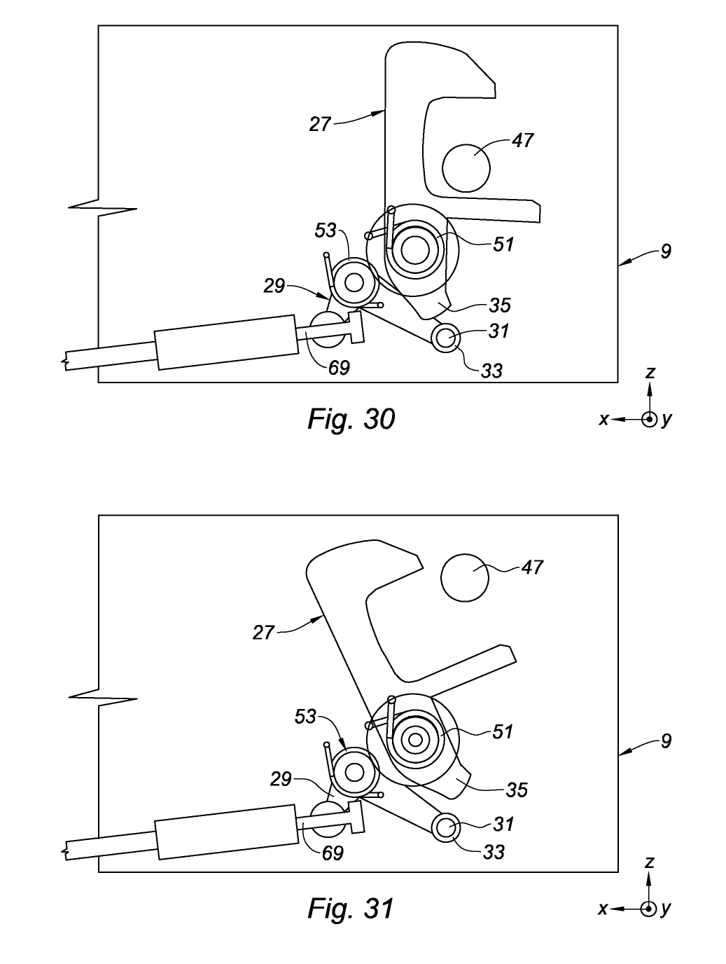

Said tensile stress has the effect of rotating the second latch 29 clockwise, thus releasing the tail 35 of the hook 27, as seen in FIG. 30. Under the effect of the spiral spring 51, the hook 27 then rotates counterclockwise, thereby releasing the pin 47 integral with the fixed structure of the thrust reverser (see FIG. 31): both doors 7 and 9 may then opened.

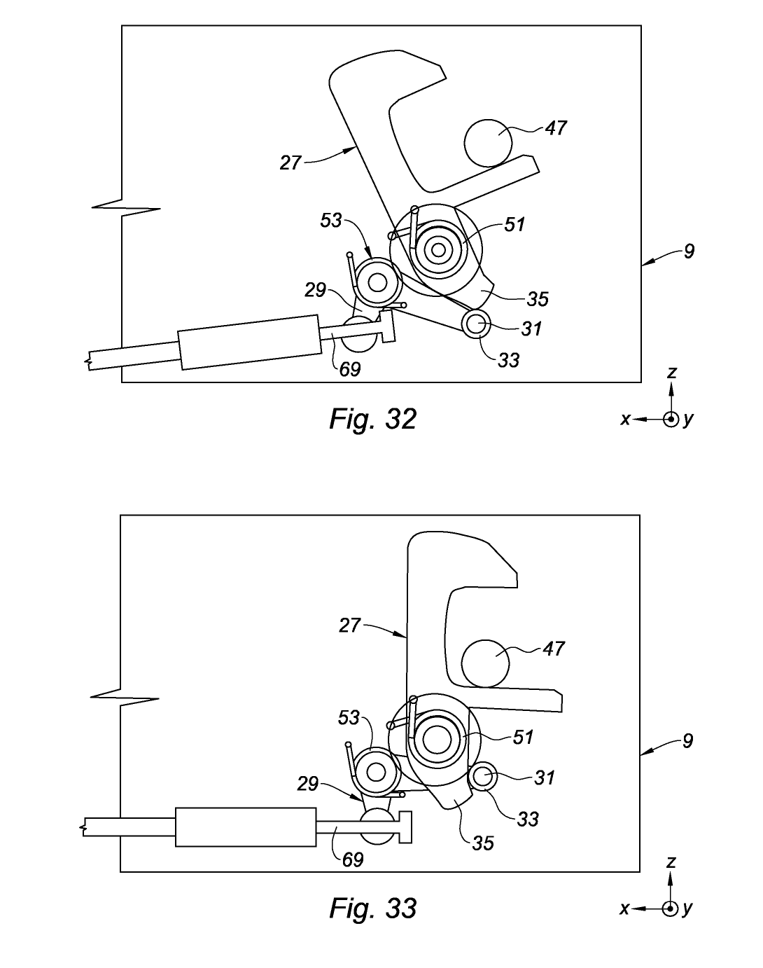

When it is desired to close the two doors, the rod 41 of the actuating cylinder 43 is retracted, which has the effect of bringing the hook 7 back into contact with the pin 47 (see FIG. 32) and thereby rotating the hook 27 against the spring 51 until the tail 35 of said hook crosses the tail 31 of the second latch 29 and is thus in the locking position shown in FIG. 33, wherein both doors 7 and 9 are perfectly immobilized.

As can be understood in the light of the foregoing description, the present disclosure provides a locking system of the twin doors which is completely independent of other locking systems (primary locking and synchronized locking), with no need for additional specific control means.

As will be understood in the light of the foregoing description, including the examination of FIG. 11, only the primary locks VPA, VPB, VPc VPD are PLCU-controlled, the other locks 25a, 25b, 25c, 25d and VSa, VSb, being actuated by solely setting the twin doors in motion by actuating cylinders 43a, 43b, 43c, 43d.

Thus, for a thrust reverser having four pairs of twin doors as shown in FIG. 11, only four locks VPA, VPB, VPc VPD require control means, which is extremely beneficial in terms of weight, cost and maintainability.

Of course, the present disclosure is by no means limited to the forms described and shown, which are only provided as mere examples.

What is claimed is:

1. A thrust reverser for an aircraft turbojet engine nacelle, comprising:
at least a pair of twin doors comprising an upstream door, a downstream door connected by at least one connecting rod to the upstream door, and
at least one actuating cylinder moving the upstream and downstream doors between a “direct jet” position wherein both the upstream and downstream doors are closed, and a “reverse jet” position wherein both the upstream and downstream doors are open and adapted to deflect at least a portion of a cold airflow flowing inside the nacelle, and
means for locking/unlocking said downstream and upstream doors one another under a sole action of said actuating cylinder.

2. The thrust reverser according to claim 1, wherein said locking/unlocking means comprise:
a hook pivotally mounted on said upstream door between a locking position of a pin integral with said downstream door, and an unlocking position of said pin,
a first elastic means for returning said hook to its locking position,
a latch pivotally mounted on said upstream door between a blocking position in which the latch holds said hook in its locking position and a release position, in which the latch allows said hook to switch from its locking position to its unlocking position,
a second elastic means for returning said latch to its blocking position,
said actuating cylinder and said latch being arranged relative to each other so that the extension of said actuating cylinder rotates said latch to its release position.

3. The thrust reverser according to claim 2, wherein said hook and said latch are pivotally mounted around axes substantially perpendicular to axes of rotation of the upstream and downstream doors and an axis “A” of the nacelle.

4. The thrust reverser according to claim 2, wherein said hook and said latch are mounted pivotably around axes substantially parallel to axes of rotation of the upstream and downstream doors.

5. The thrust reverser according to claim 2, wherein said hook is pivotally mounted around an axis substantially parallel to an axis “A” of the nacelle, and said latch is pivotally mounted around an axis substantially perpendicular to axes of rotation of the upstream and downstream doors and an axis “A” of the nacelle.

6. The thrust reverser according to claim 1, wherein said locking/unlocking means comprise:
a bolt slidably mounted in said upstream door between a locking position of a striker formed in said downstream door, and an unlocking position of said striker,
a first elastic means for returning said bolt to its locking position,
a latch pivotally mounted on said upstream door and cooperating with said bolt so that a rotation of said latch causes said bolt to slide,
said actuating cylinder and said striker being arranged relative to each other so that an extension of said actuating cylinder rotates said latch in a direction causing said bolt to slide towards its unlocking position.

7. The thrust reverser according to claim 6, wherein said locking/unlocking means further comprise a yoke pivotally mounted on said upstream door around an axis substantially parallel to axes of rotation of said upstream and downstream doors, and a third elastic means bringing said yoke back to a position wherein the yoke holds said bolt in its unlocking position.

8. The thrust reverser according to claim 7, wherein said downstream door comprises a bearing member adapted to rotate said yoke against said third elastic means.

9. The thrust reverser according to claim 1, wherein said locking/unlocking means comprise:
a hook pivotally mounted on said downstream door between a locking position of a pin integral with a fixed structure of said thrust reverser, and an unlocking position of said pin,
a first elastic means for returning said hook to its locking position,
a latch pivotally mounted on said downstream door between a blocking position in which the latch holds said hook in its locking position and a release position, in which the latch allows said hook to switch from its locking position to its unlocking position,
a second elastic means for returning said latch to its blocking position,
a cable having one end slidably mounted on said upstream door, and the other end connected to said latch, so that an extension of said actuating cylinder causes a sliding of said cable relative to said upstream door, and thereby a rotation of said latch towards its release position.

10. A nacelle equipped with a thrust reverser according to claim 1.
